(19) United States
(12) Patent Application Publication
(10) Pub. No.: US 2003/0169372 A1
(43) Pub. Date: Sep. 11, 2003

(54) OSD control method

(76) Inventors: Yu-Ming Huang, Tainan (TW); Chia-Chi Chang, Tainan Hsien (TW); Ruen-Rone Lee, Hsinchu (TW)

Correspondence Address: BIRCH STEWART KOLASCH & BIRCH, PO BOX 747, FALLS CHURCH, VA, 22040-0747, US

(21) Appl. No.: 10/087,774

(22) Filed: Mar. 5, 2002

(51) Int. Cl. H04N 5/50

(52) U.S. Cl. 348/569; 345/781

(57) ABSTRACT

An method for controlling various mode of OSD functions is provided in a display system. The method uses a display buffer with plural register for storing frame data, which corresponding to a frame. A memory is used for storing OSD data, corresponding to an OSD window included in the frame. The micro-controller copies the OSD data in the register which corresponds to the OSD window by an data processing method.

### BACKGROUND OF THE INVENTION

1. Field of the Invention

The present invention relates in general to the field of OSD control methods. In particular, the present invention relates to a method of storing OSD data in a display buffer for setting up an OSD.

2. Description of the Related Art

OSD (on screen display) usually shows display parameters for a user to adjust, such as hue, brightness, saturation, contrast, H-size, H-phase, V-size, V-center, pin-cushion, etc.

Due to many kinds of graphic data and video data, the complexity of the OSD control and the related hardwire circuits of the OSD control have become more complex. The device-oriented methods no longer meet the requirements.

FIG. 1 shows a block diagram of a OSD control circuit in a display. AS shown in FIG. 1, R(red), G(green), B(blue),represent the three color signals from the frame buffer 110. They are image signals to be displayed in a normal display mode. In normal display mode, R, G, B, image signals are sent to display panel 170 through mixer 130 and output buffer 160. The signals for controlling the positions of the image signals include HSYNC (horizontal synchronizing signal), VSYNC (vertical synchronizing signal). HSYNC and VSYNC are both a kind of pulse signal. The period of HSYNC which defines a horizontal scan line is shorter. The period of VSYNC which defines frame including plural horizontal scan line periods is longer.

When users trigger the, OSD function, the micro-controller of the display reads the character data to be displayed from a EEPROM, loads it to the OSD circuit 120, and generates three color signals Rosd, Gosd, Bosd, corresponding to the OSD displayed region. The mixer 130 receives Rosd, Gosd, Bosd, three colors signals from the OSD circuit 120, and a blank signal from the OSD blank circuit. The blank signal defines the OSD region on the screen. When the blank signal equals 1, the displayed region is in a normal display mode, the mixer 130 shuts off Rosd, Gosd, Bosd siganls and passes R, G, B signals into the output buffer 160. When the blank signal equals 0, the displayed region is in OSD mode, and the mixer 130 shuts off R, G, B, signals and passes Rosd, Gosd, Bosd signals into the output buffer 160. The blank signal is generated by the OSD blank circuit 180 which evaluates the timing sequence of the HSYNC signal and VSYNC signal. That is, the OSD region is defined by counting the horizontal and vertical scan lines. For example, the 240^{th} scan line is the beginning of the OSD region, and the height of the OSD region is 120 scan lines. When VSYNC triggers the OSD blank circuit 180, the OSD blank circuit 180 will start to count until the 240^{th} scan line, then output the blank signal which equals 0 until the 360^{th} scan line, then output the blank which equals 1.

However conventional hardwired OSD circuits lack flexibility in providing multiple OSD windows simultaneously. It requires hardwired circuits, and fabrication cost increases. Dedicated devices, such as RAM and ROM, are needed. As the prior art is device oriented instead of application oriented, there is a lack of providing various modes, such as alpha blending or color keying, in displaying an OSD window.

### SUMMARY OF THE INVENTION

Therefore, an object of the present invention is to provide an application oriented OSD control method. Instead of using a dedicated OSD circuit or device to perform OSD functions, software drivers, conventional 2D bitblt operation or video overlay are adopted to realize the OSD function in addition to specific OSD hardware.

An OSD control method comprises the following steps. Frame data, which corresponds to a frame, is stored in an display buffer with plural register. OSD data, which corresponds to an OSD window included in the frame, is stored in a memory. The OSD data in the register which corresponds to the OSD window is copied by a data processing method.

### BRIEF DESCRIPTION OF THE DRAWINGS

The present invention can be more fully understood by reading the subsequent detailed description in conjunction with the examples and references made to the accompanying drawings, wherein:

FIG. 1 is a block diagram of a OSD control circuit in a display.

FIG. 2 illustrates a block diagram of a circuit realizing OSD function by bitblt in a first embodiment of the present invention.

FIG. 3 illustrates a block diagram of a circuit realizing OSD function by video overlay in a second embodiment of the present invention.

FIG. 4 is a flow chart illustrating an OSD control method.

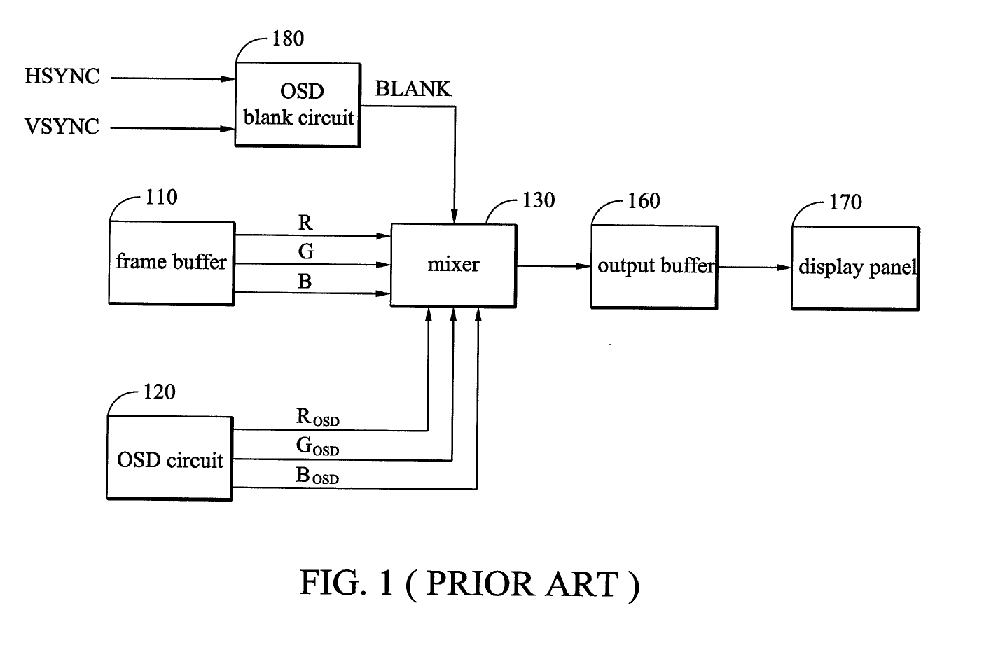

### DETAILED DESCRIPTION OF THE PREFERRED EMBODIMENT

In the OSD control method in the present invention, OSD content is copied into a display buffer, and the number of OSD windows is not limited to the number of circuits performing OSD function. OSD function can be executed more flexibly. Software can activate the OSD control any time a specific key is pressed. Conventional bitblt (bit block transfer) and video overlay can be applied to the present method without dedicated circuits. Furthermore, the OSD can be displayed alternatively by applying different functions of 2D bitblt or video overlay, such as alpha-blended bitblt, transparent bitblt, color keying, etc. The benefits of present invention is to have better OSD control, which utilizes current hardware capability, without any specific hardware support.

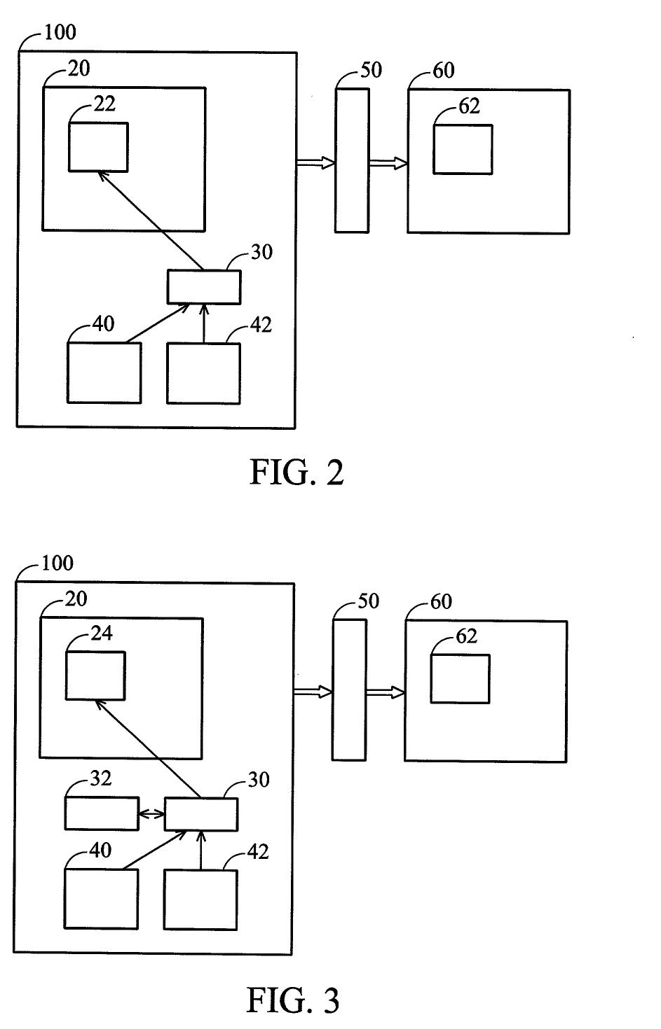

FIG. 2 illustrates a block diagram of a circuit realizing OSD function by bitblt according to a first embodiment. As shown in FIG. 2, an interface card 100 that performs OSD function includes memory 40 and 42, display buffer 20, and micro-controller 30. Memory 40,42 stores the OSD data. Display device includes display screen 60 and display driving circuit 50.

Display buffer 20 is a memory portion, which can be realized by general memory such as high speed memory, e.g., SRAM, or low speed memory, e.g., DRAM. Each memory cell, such as bit or byte, in the display buffer 20 corresponds to a pixel of the display screen 60. FIG. 2 shows the memory portion 22 storing the OSD data of the display buffer 20 corresponding to the OSD window 62 of the display screen 60. Micro-controller 30 executes bitblt (bit block transfer) according to the state of the bitblt flag, copying the OSD data in the memory 40,42 to the memory portion 22.

FIG. 3 illustrates a block diagram of a circuit realizing OSD function by video overlay according to a second embodiment. As shown in FIG. 3, an interface card 100 that performs OSD function includes memory 40 and 42, display buffer 20, and micro-controller 30. Memory 40,42 stores the OSD data. Video overlay register 32 stores parameters for video overlay such as window control, color control, and chroma control, etc. Display device includes display screen 60 and display driving circuit 50.

Display buffer 20 is a memory portion. Each memory cell, such as bit, byte, in the display buffer 20 corresponds to a pixel of the display screen 60. FIG. 3 shows the memory portion 24 storing the video overlay data of the display buffer 20 corresponding to the OSD window 62 of the display screen 60. Micro-controller 30 executes video overlay according to the state of the video overlay flag. According to the data of the video overlay register 32, micro-controller 30 sets up a memory portion 24 for video overlay window data, comparing the frame data of the memory portion 24 with the OSD data of the memory 40, 42, or performing a weighting algorithm to generate a blended signal to realize OSD with a fading appearance.

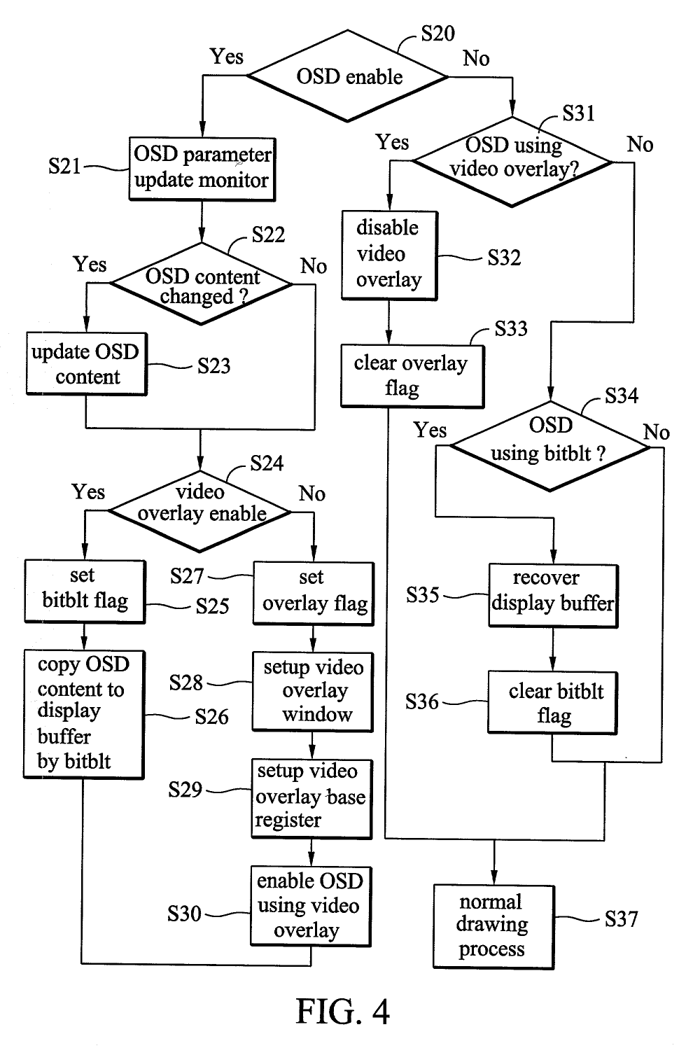

FIG. 4 is a flow chart illustrating an OSD control method, i.e. a flow chart of the control operation in the micro-controller 30.

The following steps are taken for enabling the OSD windows.

In step S20, micro-controller 30 determines whether an OSD function has been enabled. If so, step S21 is executed. If not, step S31 is executed.

In step S21, the OSD function has been enabled, and the OSD frame is updated by the OSD parameter.

In step S22, whether the OSD data in a memory is changed is determined. If so, step S23 is executed.

In step S23, the OSD data in the memory is changed, and micro-controller 30 updates the OSD data.

In step S24, whether a video overlay function is enabled is determined. If so, step S25 is executed. If not, step S27 is executed.

In step S25, the video overlay function is enabled, and a bit block transfer flag is set up.

In step S26, the OSD data, which corresponds to the OSD window, is copied into the registers of a display buffer by bit block transfer.

In step S27, the video overlay function is disabled, which is determined in step S24, and a video overlay window is set up.

In step S28, a video overlay flag is set up.

In step S29, a video overlay register is set up.

In step S30, the video overlay function is enabled such that display the OSD window.

The following steps are taken for disabling the OSD window.

In step S31, The OSD function is disabled, which is determined in step S20. Whether the OSD window is provided by the video overlay function is determined. If so, step S32 is executed. If not, step S34 is executed.

In step S32, the OSD window is provided by the video overlay function, and the video overlay function is disabled.

In step S33, the video overlay flag is cleared.

In step S34, the OSD window is not provided by video overlay, which is determined in step S31, and whether OSD window is provided by bit block transfer is determined. If so, step S35 is executed. If not, step S36 is executed directly.

In step S35, the OSD window is provided by bit block transfer. The data which corresponds to the OSD window in the registers of the display buffer is recovered.

In step S36, the bit block transfer flag is cleared.

In step S37, normal drawing is processed.

Instead of using dedicated OSD circuits or devices to perform the OSD function, conventional 2D biblt or video overlay are adopted by the present invention to realize the OSD function as well as specific OSD circuits or devices. The application or driver can prepare and manage the OSD content within system memory or local memory for flexibility. Furthermore, the OSD can be displayed differently by applying different functions of 2D bitblt or video overlay, such as alpha blended bitblt, transparent bitblt, color keying, etc.

While the invention has been described with reference to various illustrative embodiments, the description is not intended to be construed in a limiting sense. Various modifications of the illustrative embodiments, as well as other embodiments of the invention, will be apparent to those persons skilled in the art upon reference to this description. It is therefore contemplated that the appended claims will cover any such modification or embodiments as may fall within the scope of the invention defined by the following claims and their equivalents.

What is claimed is:

1. An OSD control method comprising:
storing frame data, which corresponds to a frame, in an display buffer with plural registers;
storing OSD data, which corresponds to an OSD window included in the frame, in a memory;
copying the OSD data in the register corresponding to the OSD window by an data processing method.

2. The OSD control method as claimed in claim 1, wherein the data processing method is bit block transfer.

3. The OSD control method as claimed in claim 1, wherein the data processing method is video overlay.

4. The OSD control method as claimed in claim 1, wherein, the steps of copying the OSD data in the register comprises:
setting up a bit block transfer flag; and
copying the OSD data in the register of the display buffer corresponding to the OSD window by bit block transfer.

5. The OSD control method as claimed in claim 4, wherein, further comprising the steps of:
recovering the data in the register of the display buffer which corresponds to the OSD window; and
clearing the bit block transfer flag.

6. The OSD control method as claimed in claim 1, wherein, the steps of copying the OSD data in the register comprises:
setting up a video overlay flag;
setting up a video overlay window;
setting up a video overlay register; and
enabling a video overlay function displaying the OSD window.

7. The OSD control method as claimed in claim 6, wherein, further comprising the steps of:
disabling the video overlay function; and
clearing the video overlay flag.
